(19) United States
(12) Patent Application Publication
(10) Pub. No.: US 2011/0007973 A1
(43) Pub. Date: Jan. 13, 2011

(54) APPARATUS FOR REMOVING IMAGE NOISE AND METHOD THEREOF

(75) Inventors: Tae Hyeon KWON, Gyeonggi-do (KR); Won Tae CHOI, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon-si (KR)

(21) Appl. No.: 12/575,322

(22) Filed: Oct. 7, 2009

(30) Foreign Application Priority Data
Jul. 10, 2009 (KR) 10-2009-0062932

(51) Int. Cl. G06K 9/40; G06K 9/48; G06K 9/62

(52) U.S. Cl. 382/199; 382/261; 382/224

(57) ABSTRACT

The present invention relates to an apparatus for removing image noise and a method thereof. There is provided with an apparatus for removing image noise including a buffer register that divides image signals in an n*n area obtained from an image sensor into brightness components and chroma components to store them as pixel values; an image analyzing unit that classifies the n*n area stored in the buffer register into a contour area, a texture area, and a planarization area; and a noise reduction unit that designs noise removal filters according to the features of the classified areas to reduce image noise.

### CROSS REFERENCES RELATED APPLICATIONS

The present application claims priority under 35 U.S.C. 119 and 35 U.S.C. 365 to Korean Patent Application No. 10-2009-0062932 (filed on Jul. 10, 2009), which is hereby incorporated by reference in its entirety.

### BACKGROUND OF THE INVENTION

1. Field of the Invention

The present invention relates to an apparatus for removing image noise and a method thereof, and more particularly, to an apparatus for removing image noise that classifies the entire image into a contour area, a texture area, and a planarization area using correlation of each pixel and correlation of sub areas and then designs a noise removal filter in consideration of the features of the respective areas to remove image noise, and a method thereof.

2. Description of the Related Art

Recently, a digital photographing equipment such as a digital still camera or a digital camcorder has come into wide use and an image photographed by such a digital photographing equipment includes noise component that degrades image quality.

The noise of the digital image is due to physical property and instability of an image sensor in the photographing apparatus and is also generated during a process of processing/treating an image signal. Therefore, in order to obtain an image having more improved image quality, the removal of noise is indispensable.

First, there is a method to apply a low pass filter (LPF) to an image signal including noise component, wherein the low pass filter obtains an average value or an average value with weight of image information of a target pixel and a peripheral pixel, thereby making it possible to adjust filtering intensity of the image signal. Although this method is able to reduce computations and shows an excellent noise removing performance in the planarization area of the image, it also has disadvantages that if the low pass filter is applied to all image signals, it reduces contour information as well as the noise component to degrade definition of the image.

Next, there is a method to select only a pixel including noise component using the correlation of a target pixel and a peripheral pixel and to selectively apply a low pass filter to only an image signal including the noise component. However, this method also has a limitation in distinguishing noise information from contour information. Further, since only a second order low pass filter to simply use a target pixel and a peripheral pixel is applied, this method has a problem that directionality of the contour cannot be considered.

In order to solve the problems, the most widely used method for removing noise component of the image signal is a method for removing noise, while preserving the contour. The method for removing noise, while preserving the contour, is a method that extracts directionality information of the contour using the correlation of the target pixel and the peripheral pixel and applies a first order low pass filter in the direction of the contour to enable to remove noise simultaneously with preserving definition of the contour. The method has proper computations and complexity and facilitates a hardware design.

However, the method for removing noise, while preserving the contour, effectively removes noise in a specific image area but has a limitation in removing noise in a planarization area. Also, the method does not consider the complexity of the image, the brightness of the pixel, the noise pattern, etc., such that it has a limitation in removing the noise component.

### SUMMARY OF THE INVENTION

It is an object of the present invention to provide an apparatus for removing image noise that classifies the entire image into a contour area, a texture area, and a planarization area using a pixel value of an input image and designs a noise removal filter by considering the features of the classified areas to remove image noise, and a method thereof.

According to one aspect of the present invention, there is provided an apparatus for removing image noise including: a buffer register that divides image signals in an n*n area obtained from an image sensor into brightness components and chroma components to store them as pixel values; an image analyzing unit that classifies the n*n area stored in the buffer register into a contour area, a texture area, and a planarization area; and a noise reduction unit that designs noise removal filters according to the features of the classified areas to reduce image noise.

Further, the image analyzing unit of the apparatus for removing image noise according to the present invention may include: a contour area detection unit that calculates each first absolute difference value in vertical, horizontal, and diagonal directions of two adjacent pixel values based on a center pixel in the n*n area stored in the buffer register and classifies the n*n area into the contour area and an non-contour area using the calculated first absolute difference values to determine a contour direction, and extracts at least one m*m sub area according to the contour direction based on the center pixel and calculates second absolute difference values in the respective sub areas to detect continuity of the contour area; and a texture area/planarization area detection unit that calculates third absolute difference values of l*l sub areas included in the non-contour area to classify the non-contour area into a texture area and a planarization area.

Moreover, the apparatus for removing image noise according to the present invention may further include: a filter coefficient adjustment unit that assigns weight according to external environmental factors to adjust the coefficients of the noise removal filters.

Preferably, the contour area detection unit of the apparatus for removing image noise according to the present invention may compare final absolute difference values that are differences of the first absolute difference values in the vertical/horizontal directions and differences of the first absolute difference values in the diagonal directions with a first threshold value, classifying the n*n area as the contour area if the final absolute difference value is larger than the first threshold value and classifying the n*n area as the non-contour area if the final absolute difference value is smaller than the first threshold value.

Preferably, the contour area detection unit of the apparatus for removing image noise according to the present invention may determine a contour direction in a direction vertical to a direction where the largest first absolute difference value of the four first absolute difference values is calculated.

Preferably, the contour area detection unit of the apparatus for removing image noise according to the present invention may calculate each second absolute difference value to vertical, horizontal, and diagonal directions of adjacent two pixel values based on the center pixel of the respective m*m sub areas, if the maximum values of the second absolute difference values calculated from the respective sub areas are in the same direction, the contour direction being detected as being continuous in the sub areas of the contour area.

Preferably, if the contour direction in the respective m*m sub areas is detected as being continuous, the noise reduction unit of the apparatus for removing image noise according to the present invention may be designed as a first order low pass filter.

Preferably, the texture area/planarization area detection unit of the apparatus for removing image noise according to the present invention may calculate third absolute difference values for vertical, horizontal, and diagonal directions based on a center pixel in the l*l sub areas, classifying the l*l sub areas as the planarization area if all of the calculated third absolute difference values are smaller than a third threshold value and classifying the l*l areas as the texture area if at least one of the calculated third absolute difference values is larger than the third threshold value.

Preferably, if the image analyzing unit of the apparatus for removing image noise according to the present invention classifies the n*n area as the planarization area or the texture area, the noise reduction unit may classify the n*n area into five sub areas based on the center pixel of the n*n area and calculate four absolute difference values based on the center pixel of the five sub areas to compare them with a fourth threshold value and thus to design noise removal filters.

Preferably, the noise reduction unit of the apparatus for removing image noise according to the present invention may be designed as any one of a first order low pass filter, a second order low pass filter, an intermediate value filter, and a bypass filter.

According to another aspect of the present invention, there is provided a method for removing image noise including: dividing image signals in an n*n area obtained from an image sensor into brightness components and chroma components and storing them in a buffer register as pixel values; classifying the n*n area into a contour area, a texture area, and a planarization area using the pixel values in the n*n area stored in the buffer register; and designing noise removal filters according to the features of the classified areas.

Preferably, the method for removing the image noise according to the present invention may further include: adjusting coefficients of the noise removal filters by assigning weight according to external environmental factors.

Preferably, in the method for removing the image noise to the present invention, the classifying the n*n area into the contour area, the texture area, and the planarization area may include: calculating each first absolute difference value to vertical, horizontal, and diagonal directions of adjacent two pixel values based on a center pixel of the n*n area stored in the buffer register; classifying the n*n area into the contour area and an non-contour area using the calculated first absolute difference values and then determining a contour direction; extracting at least one m*m sub area based on the center pixel according to the contour direction and calculating second absolute difference values from the respective sub areas to detect continuity of the contour area; and calculating third absolute difference values in l*l sub areas included in the non-contour area and classifying the non-contour area into a texture area and a planarization area.

Preferably, in the method for removing the image noise according to the present invention, the classifying the n*n area into the contour area and the non-contour area using the calculated first absolute difference values and then determining the contour direction may include: comparing final absolute difference values that is the differences between the vertical/horizontal first absolute difference values and the difference between the diagonal first absolute difference values with a first threshold value, classifying the n*n area as the contour area if the final absolute difference values are larger than the first threshold value and classifying the n*n area as the non-contour area when the final absolute difference values are smaller than the first threshold value; and determining the contour direction to be a direction vertical to a direction that the largest first absolute difference value of the four first absolute difference values is calculated.

Preferably, in the method for removing the image noise according to the present invention, the extracting at least one m*m sub area based on the center pixel according to the contour direction and calculating second absolute difference values from the respective sub areas to detect continuity of the contour area may include: calculating each second absolute difference value to vertical, horizontal, and diagonal directions of adjacent two pixel values based on a center pixel of the respective m*m sub areas; and when the maximum values of the second absolute difference values extracted from the respective sub areas are in the same direction, detecting the contour direction as being continuous in the sub areas of the contour area.

Preferably, in the method for removing the image noise according to the present invention, the calculating the third absolute difference values in l*l sub areas included in the non-contour area and classifying the non-contour area into a texture area and a planarization area may include: calculating third absolute difference values for vertical, horizontal, and diagonal directions based on a center pixel in the l*l sub areas, classifying the l*l sub areas as the planarization area if all of the calculated third absolute difference values are smaller than a third threshold value and classifying the l*l sub areas as the texture area if at least one of the calculated third absolute difference values is larger than the third threshold value.

Preferably, in the method for removing the image noise according to the present invention, the designing the noise removal filters according to the features of the classified areas may include classifying the planarization area or the texture area into five sub areas based on the center pixel in the n*n area, calculating four absolute difference values based on the center pixel of the five sub areas and comparing them with a fourth threshold value to classify the features of the areas and to design noise removal filter according to the features of the respective areas.

### BRIEF DESCRIPTION OF THE DRAWINGS

FIG. 1 is a constitutional diagram of an apparatus for removing image noise according to an embodiment of the present invention;

FIG. 2 is a schematic flowchart showing a method for removing image noise according to the present invention;

FIG. 3 is a diagram showing an embodiment where the entire image displays the calculation directions of the pixel coordinate values and the first absolute difference values of image signals into which image signals in a 5*5 area are input, in order to specifically explain a method for removing image noise according to an embodiment of the present invention;

FIG. 4 is a flowchart designing a noise reduction filter in a contour area in a method for removing image noise according to an embodiment of the present invention;

FIGS. 5A-D are diagrams indicating sub areas according to contour directions in a method for removing image noise according to one or more embodiments of the present invention;

FIG. 6 is a diagram indicating an n*n area as l*l sub areas in order to classify a texture area and a planarization area when the n*n area is classified as an non-contour area in a method for removing image noise according to an embodiment of the present invention;

FIG. 7 is a flowchart showing a method for designing a noise reduction filter when an n*n area is classified as a planarization area in a method for removing image noise according to an embodiment of the present invention;

FIG. 8 is a flowchart showing a method for designing a noise reduction filter when an n*n area is classified as a texture area in a method for removing image noise according to an embodiment of the present invention; and

FIG. 9 is a diagram comparing an image obtained when a method for removing image noise in the related art is used with an image obtained when a method for removing image noise according to an embodiment of the present invention is used.

### DESCRIPTION FOR KEY ELEMENTS IN THE DRAWINGS

100: Image noise processing apparatus

110: Buffer register

120: Image analyzing unit

122: Contour area detection unit

124: Texture area/planarization area detection unit

130: Noise reduction unit

131: First order low pass filter

132: Second order low pass filter

133: Intermediate value filter

134: Bypass filter

140: Filter coefficient adjustment unit

### DETAILED DESCRIPTION OF THE PREFERRED EMBODIMENTS

The present invention will now be described more fully hereinafter with reference to the accompanying drawings, in which exemplary embodiments of the invention are illustrated. The present invention may, however, be embodied in different forms and should not be construed as limited to the embodiments set forth herein. Rather, the present invention is intended to cover various modifications and equivalent arrangements included within the spirit and scope of the appended claims, and equivalent thereof.

Hereinafter, an apparatus for removing image noise and a method thereof according to an embodiment of the present invention will be described in detail with reference to the accompanying drawings, and the same or corresponding constituents irrespective of drawing reference numerals will be given with the same reference numerals and the overlapped explanation thereof will be omitted.

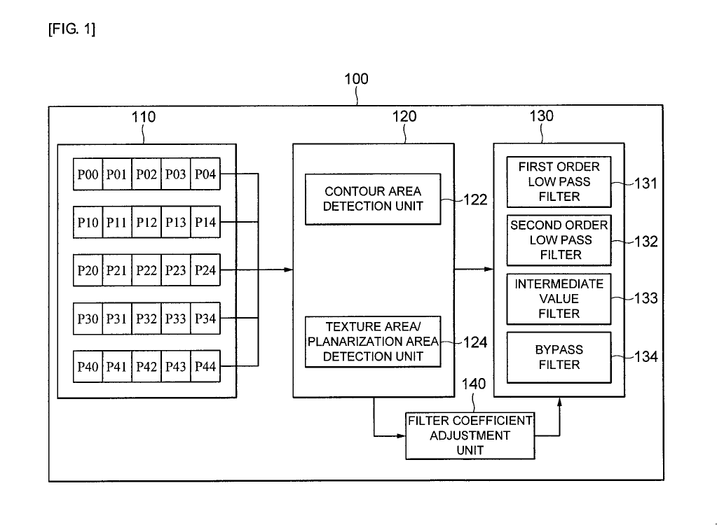

FIG. 1 is a constitutional diagram of an apparatus for removing image noise according to an embodiment of the present invention.

Referring to FIG. 1, the apparatus for removing image noise 100 includes a buffer register 110, an image analyzing unit 120, a noise reduction unit 130, and a filter coefficient adjustment unit 140, wherein the image analyzing unit 120 may include a contour area detection unit 122 and a texture area/planarization area detection unit 124, and the noise reduction unit 130 may include a first order low pass filter 131, a second order low pass filter 132, an intermediate value filter 133, and a bypass filter 134.

The buffer register 110 divides image signals in an n*n area obtained from an image sensor into brightness components and chroma components to store them as pixel values. The embodiment shows the buffer register in which the image signals in a 5*5 area are stored.

The image analyzing unit 120 classifies the n*n area stored in the buffer register 110 into a contour area, a texture area, and a planarization area, and includes the contour area detection unit 122 and the texture area/planarization area detection unit 124.

The contour area detection unit 122 calculates each first absolute difference value to vertical v, horizontal h, and diagonal r and l directions of two adjacent pixel values based on a center pixel in the n*n area stored in the buffer register 110, and classifies the n*n area into the contour area and an non-contour area using the calculated first absolute difference values, thereby making it possible to determine a contour direction.

Further, the contour area detection unit 122 extracts at least one m*m sub area based on the center pixel according to the contour direction and calculates second absolute difference values from the respective sub areas, thereby making it possible to detect continuity of the contour area.

The contour area detection unit 122 compares the final absolute difference values that are differences of the first absolute difference values in the vertical/horizontal directions and differences of the first absolute difference values in the diagonal directions with a first threshold value, wherein if the final absolute difference values are larger than the first threshold value, it classifies the n*n area as the contour area, and if the final absolute difference values are smaller than the first threshold value, it classifies the n*n area as the non-contour area.

If the contour area and the non-contour area are classified, the contour area detection unit 120 determines a contour direction in the direction vertical to the direction that the largest first absolute difference value of four first absolute difference values is calculated.

At this time, each second absolute difference value is calculated for vertical, horizontal, and diagonal directions of two adjacent pixel values based on a center pixel in each m*m sub area, wherein if the maximum values of the second absolute difference values calculated from the respective sub areas are in the same direction, the contour direction is detected as being continuous in the sub areas of the contour area.

The texture area/planarization area detection unit 124 calculates third absolute difference values in l*l sub areas included in the non-contour area and classifies the l*l sub areas into the texture area and the planarization area.

The texture area/planarization area detection unit 124 calculates the third absolute difference values in vertical, horizontal, and diagonal directions based on a center pixel in the l*l sub areas, wherein if all of the calculated third absolute difference values are smaller than a third threshold value, it is classified as the planarization area, and if at least one of the third absolute difference values is larger than the third threshold value, it is classified as the texture area.

A method for removing image noise according to an embodiment of the present invention includes: dividing image signals in an n*n area obtained from an image sensor into brightness components and chroma components to store them in a buffer register as pixel values; classifying the n*n area into a contour area, a texture area, and a planarization area using the pixel values of the n*n area stored in the buffer register; and designing a noise removal filter according to the features of the classified areas.

Further, the method for removing the image noise according to the embodiment of the present invention further includes adjusting coefficients of the noise removal filter by assigning weight according to external environmental factors.

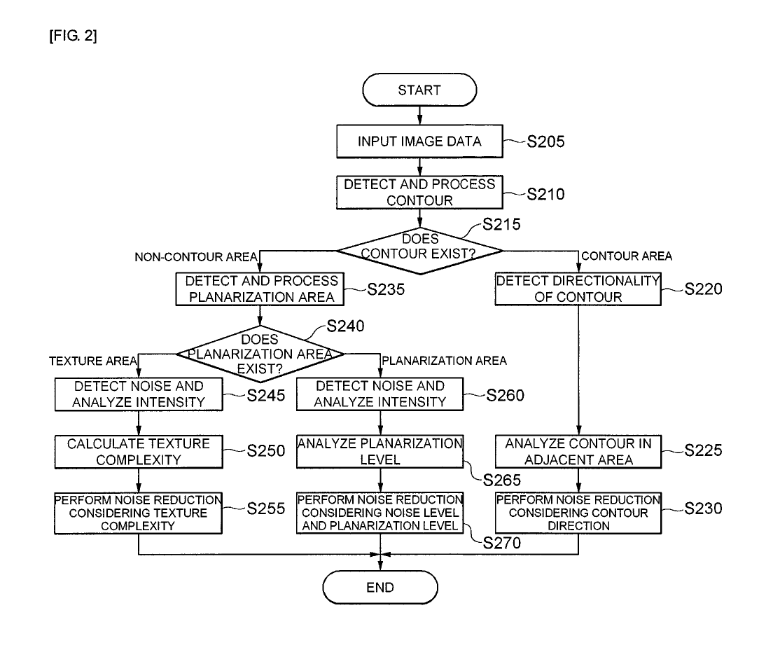

FIG. 2 is a schematic flowchart showing a method for removing image noise according to the present invention.

First, if image signals in an n*n area obtained from an image sensor are classified into brightness components and chroma components and pixel values are input as image data (or image signals) (S205), it is detected whether a contour is included in the n*n area (S210).

It is determined whether the n*n area is the contour area (S215) and when the n*n area is determined to be the contour area, directionality of the contour is detected (S220) and then directionality of the contour of adjacent areas (or sub areas) is analyzed (S225).

A noise removal filter is designed in consideration of contour directions of the respective areas according to whether the contour direction of the adjacent area coincides with the contour direction of the central area, thereby making it possible to perform noise reduction (S230).

Further, when the n*n area is determined to be an non-contour area, it is detected whether the n*n area is a texture area or a planarization area (S235), and noise removal filters can be designed according to features of the respective areas (S245 to S270).

Hereinafter, each step of the method for removing the image noise according to the present invention will be described in detail.

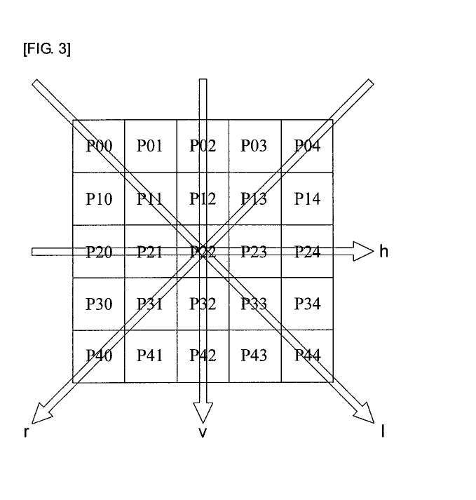

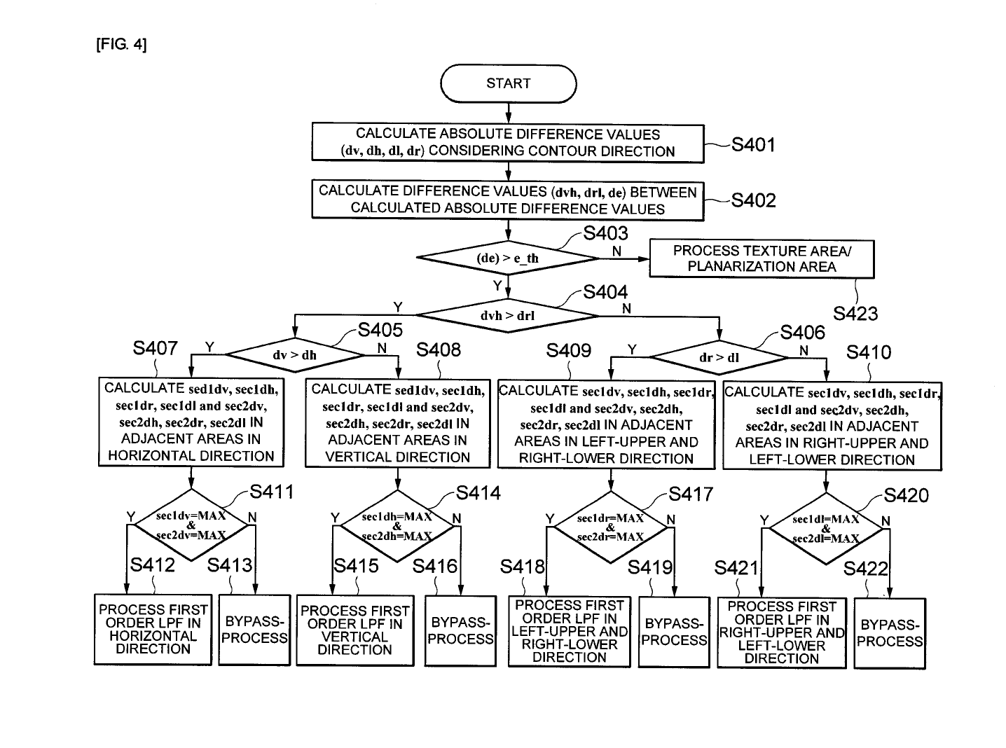

FIGS. 3 to 5 are diagrams explaining a method for detecting whether the n*n area is the contour area or the non-contour area according to the method for removing the image noise according to the present invention, and a method for designing the noise removal filter when the n*n area is detected as the contour area.

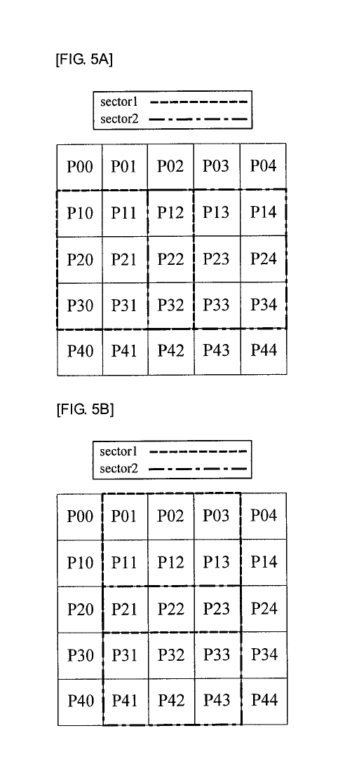

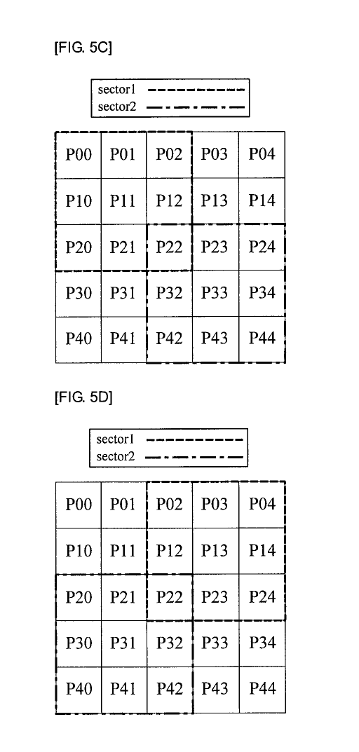

FIG. 3 is a diagram showing an embodiment where the entire image displays the calculation directions of the pixel coordinate values and the first absolute difference values of image signals into which image signals in a 5*5 area are input, in order to specifically explain a method for removing image noise according to an embodiment of the present invention, FIG. 4 is a flowchart designing a noise reduction filter in a contour area in a method for removing image noise according to an embodiment of the present invention, and FIG. 5 is a diagram indicating sub areas according to contour directions.

First, P22 that is the center pixel represents a pixel to be corrected, and a pixel coordinate value may be represented by Pxy from a left top end. Herein, x represents a row and y represents a column, wherein x and y may have 0, 1, 2, 3, and 4, respectively.

The image analyzing unit 120 of the apparatus for removing image noise according to an embodiment of the present invention calculates first absolute difference values in vertical v, horizontal h and diagonal r and l directions based on the center pixel P22, as shown in FIG. 3, in order to determine whether it is the contour area or the non-contour area (S401).

In other words, the first absolute difference values in the vertical v, horizontal h, and diagonal r and l directions based on the center pixel P22 are calculated, respectively, by the following [Equation 1].

dv=|P10−P30|+|P11−P31|+|P12−P32|+|P13−P33|+|P14−P34|

dh=P01−P03|+|P11−P13|+|P21−P23|+|P31−P33|+|P41−P43|

dr=|P10−P01|+|P21−P12|+|P32−P23|+|P43−P34|+|P31−P13|

dl=|P03−P14|+|P12−P23|+|P21−P32|+|P30−P41|+|P11−P33| [Equation 1]

Herein, dv represents the first absolute difference value in the vertical direction, dh represents the first absolute difference value in the horizontal direction, and dr and dl represent the first absolute difference value in the diagonal directions.

Further, the difference dvh between the first absolute difference values in the vertical/horizontal directions, the difference drl between the first absolute difference values in the diagonal directions, and the final absolute difference values de are calculated by the following [Equation 2] (S402).

dvh=|dv−dh|,drl=|dr−dl|

dₑ=|dvh−drl| [Equation 2]

Herein, dvh represents the difference between the first absolute difference values in the vertical/horizontal directions, drl represents the difference between the first absolute difference values in the diagonal directions, and de represents the final absolute difference values.

The final absolute difference values and the first threshold value e_th calculated through [Equation 1] and [Equation 2] are compared so that it is classified as the contour area and the non-contour area.

In other words, when the final first absolute difference value de is smaller than or equivalent to the first threshold value e_th, it is classified as the non-contour area (S423), and when the final first absolute difference value de is larger than the first threshold value e_th, it is classified as the contour area.

Further, the contour direction is determined to be a direction vertical to the direction having the largest value of the first absolute difference values dh, dv, dr, and dl in the respective directions.

If the contour direction is determined, at least one m*m sub area is extracted based on the center pixel according to the contour direction and second absolute difference values are calculated in the respective sub areas, thereby detecting continuity of the contour area.

For example, when the first absolute difference value dh in the horizontal direction of the first absolute difference values in the n*n area is the largest, the contour direction is determined to be the vertical direction, and two m*m sub areas (see FIG. 5(b)) are extracted based on the center pixel P22 according to the vertical direction that is the contour direction, thereby calculating second absolute difference values in the respective sub areas (S407, S408, S409, and S410).

The second absolute difference values in the sub areas are calculated by the following [Equation 3], wherein in [Equation 3] exemplifying a case where the contour direction is the vertical direction, even when the contour direction is the horizontal and diagonal directions, the second absolute difference values are calculated based on the center pixel of the respective sub areas.

sec1_{dv=}|P01−P21|+|P02−P22|+|P03−P23|

sec1_{dh=}|P01−P03|+|P11−P13|+|P21−P23|

sec1_{dr=}|P01−P23|+|P02−P13|+|P11−P22|

sec1_{dl=}|P11−P02|+|P21−P03|+|P22−P13|

sec2_{dv=}|P21−P41|+|P22−P42|+|P23−P43|

sec2_{dh=}|P21−P23|+|P31−P33|+|P41−P43|

sec2_{dr=}|P21−P43|+|P22−P33|+|P31−P42|

sec2_{dl=}|P31−P22|+|P41−P23|+|P42−P33| [Equation 3]

When the contour directions of the respective sub areas are coincided, a first order low pass filter (LPF) is designed in the contour direction to remove noise (S412), and when the contour directions of the respective sub areas are not coincided, they are bypass-processed (S413).

In other words, when the second absolute difference value in the vertical direction of the second absolute difference values in two sub areas is the largest, the contour direction is determined to be continuous in the horizontal direction. Therefore, the first order low pass filter is designed in the horizontal direction, making it possible to remove noise (S412).

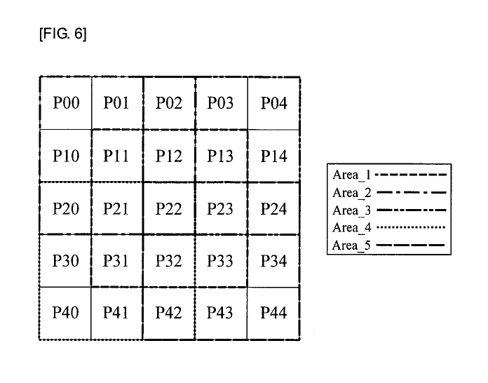

FIGS. 6 to 8 are diagrams explaining methods for classifying whether the n*n area is a texture area or a planarization area when the n*n area is detected as the non-contour area according to the method for removing image noise according to the present invention, and designing noise removal filters according to features of the respective areas.

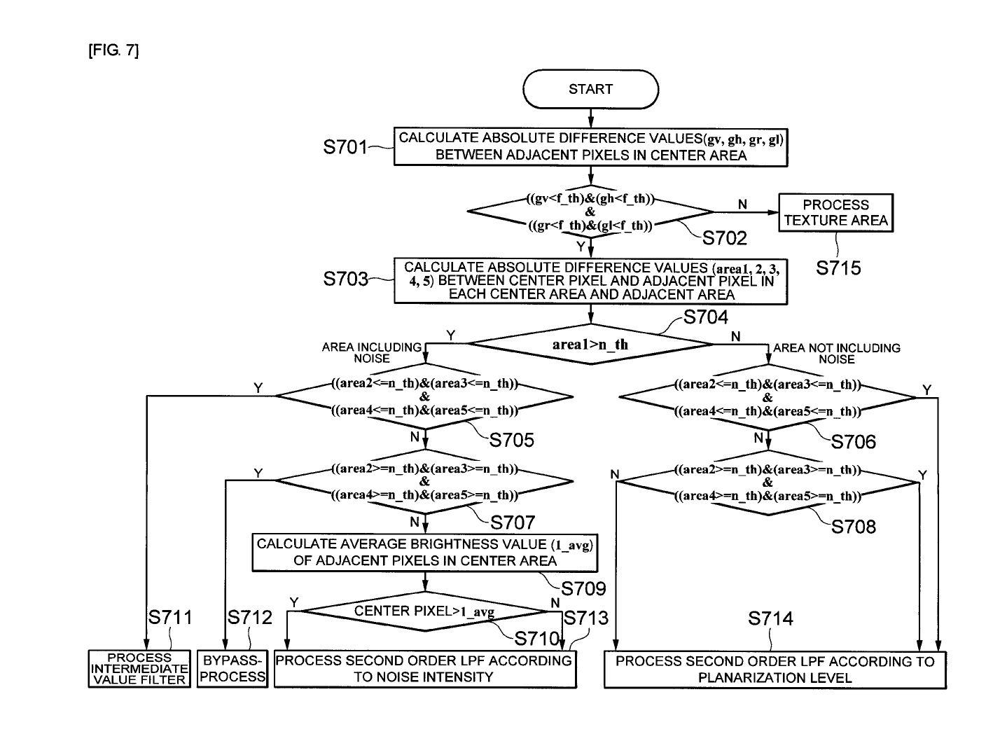

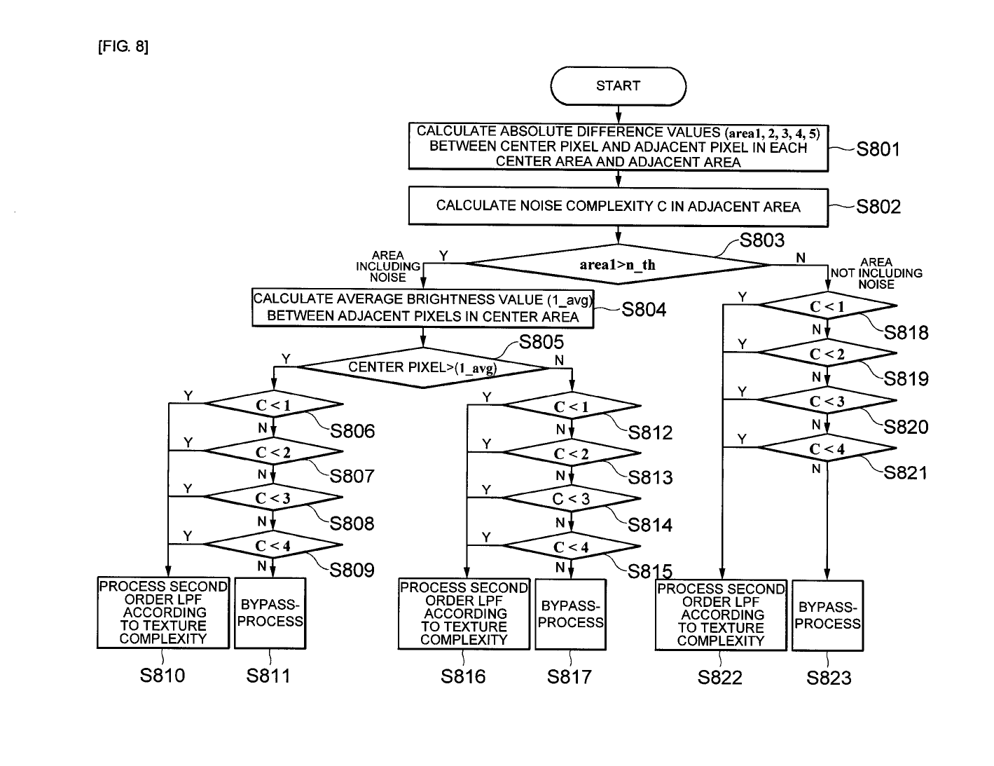

FIG. 6 is a diagram indicating an n*n area as 1*1 sub areas in order to classify a texture area and a planarization area when the n*n area is classified as the non-contour area, FIG. 7 is a flowchart showing a method for designing a noise reduction filter when the n*n area is classified as the planarization area, and FIG. 8 is a flowchart showing a method for designing a noise reduction filter when the n*n area is classified as the texture area.

In order to classify the texture area and the planarization area, the non-contour area is divided into l*l sub areas and the third absolute difference values in vertical, horizontal, and diagonal directions are calculated for the l*l sub areas.

The third absolute difference values are calculated using eight pixel values right adjacent to a center pixel of the respective sub areas. The third absolute difference value in Area_1 is calculated by the following [Equation 4], and the third absolute difference values in Area_2, Area_3, Area_4, and Area_5 are also calculated in the same manner (See FIG. 6).

gv=|P12−P32|,gh=P21−P23|,gr=|P13−P31|,gl=|P11−P33|

The four third absolute difference values gv, gh, gr, and gl calculated by the respective [Equation 4] and a third threshold value f_th are compared, wherein if all of the four third absolute difference values are smaller than the third threshold value, it is classified as the planarization area, and if at least one of the four third absolute difference values is larger than the third threshold value, it is classified as the texture area.

If the non-contour area is classified as the texture area or the planarization area, it is classified into five sub areas Area_1, Area_2, Area_3, Area_4, and Area_5 based on the center pixel in the n*n area, and fourth absolute difference values area₁, area₂, area₃, area₄, and area₅ are calculated based on the center pixel of the five sub areas and is compared with a fourth threshold value n_th to classify the features of the areas, thereby designing noise removal filters according to the respective classified features.

The fourth absolute difference values may be calculated by the following [Equation 5].

area₁₌|P22−P12|+|P22−P21|+|P22−P23|+|P22−P32|

area₂₌|P11−P01|+|P11−P10|+|P11−P12|+|P11−P21|

area₃₌|P13−P03|+|P13−P12|+|P13−P14|+|P13−P23|

area₄₌|P31−P21|+|P31−P30|+|P31−P32|+|P31−P41|

area₅₌|P33−P23|+|P33−P32|+|P33−P34|+|P33−P43| [Equation 5]

FIG. 7 is a flowchart showing a method for designing a noise reduction filter in a planarization area in the method for removing image noise according to an embodiment of the present invention, and FIG. 8 is a flowchart showing a method for designing a noise reduction filter in a texture area in a method for removing image noise according to an embodiment of the present invention.

For the planarization area, the fourth absolute difference values are calculated using [Equation 5] and the respective fourth absolute difference values are compared with the fourth threshold value n_th, thereby making it possible to design noise removal filters according to the features of the areas.

For example, area₁ that is the fourth absolute difference value in area1 including the center pixel P22 of the n*n entire areas and the magnitude of the fourth threshold value n_th are compared, thereby classifying whether it is an area including noise or an area not including noise (S702).

In the case of the area including noise, it is classified into an intermediate value filter processing area (S711) and a bypass processing area (S712) by comparing the fourth absolute difference values area₂, area₃, area₄, and area₅ in the four sub areas area2, area3, area4, and area5 with the fourth threshold value n_th (S705 and S707), and it calculates an average brightness value 1_avg of adjacent pixel values other than the center pixel P22 in the area1 (S709), compares the calculated average brightness value 1_avg with the brightness value of the center pixel P22, and then classifies it into a second order low pass filter (LPF) processing area according to noise intensity (S713), thereby designing noise reduction filters according to the features of the respective areas.

Further, in the case of the area not including noise, it compares the fourth absolute difference values area₂, area₃, area₄, and area₅ in the four sub areas area2, area3, area4, and area5 with the fourth threshold value n_th are compared (S706 and S708), making it possible to design a low pass filter (LPF) according to planarization levels (S714).

For the texture area, it compares the fourth absolute difference values area₂, area₃, area₄, and area₅ in the area2 to area5 with the fourth threshold value n_th to determine noise complexity in the respective areas as “1” or “0” and then adds the respective noise complexities to determine a final noise complexity.

In other words, if the noise complexities C_1, C_2, C_3, and C_4 in the adjacent areas are determined to be “1” when the respective area₂, area₃, area₄, and area₅ are larger than n_th, or they are determined to be “0” when the respective area₂, area₃, area₄, and area₅ are smaller than or equivalent to n_th. The final noise complexity C is calculated by adding the noise complexities C_1, C_2, C_3, and C_4 in the adjacent areas.

For the texture area, after comparing the fourth absolute difference value area₁ in Area_1 with the fourth threshold value n_th, it is classified into the area including noise and the area not including noise (S803), wherein for the area including noise, the average brightness value 1_avg of the adjacent pixels and the brightness value of the center pixel P22 are compared in the center area Area_1 (S805) and then noise reduction filters can be designed according to the final noise complexity C (S806 to S817), and for the area not including noise, noise reduction filters can be designed according to the final noise complexity C (S818 to S823).

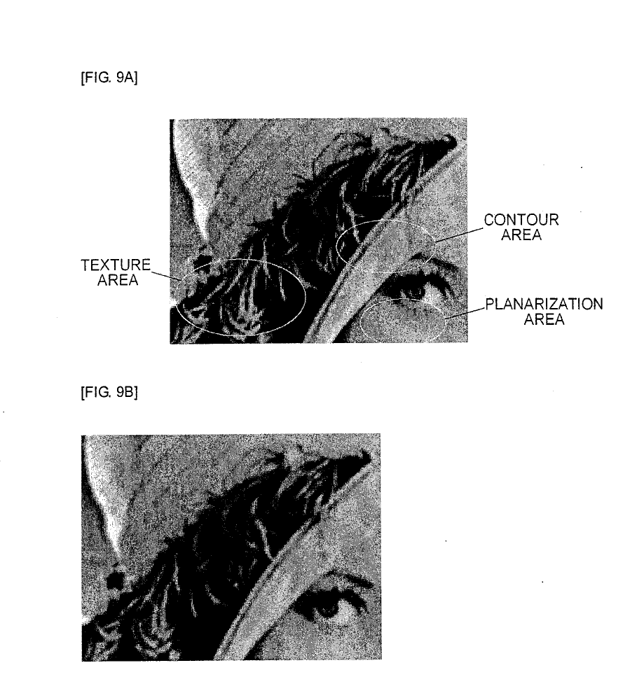

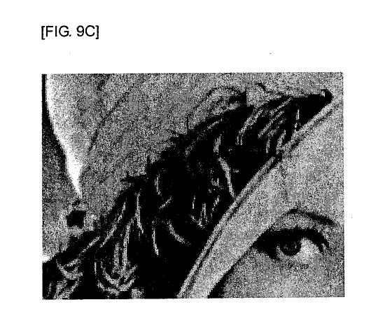

FIG. 9 is a diagram comparing an image obtained when a method for removing image noise in the related art is used with an image obtained when a method for removing image noise according to an embodiment of the present invention is used.

As shown in FIG. 9, when comparing an original image (a), an image obtained when a method for removing image noise in the related art is used (b), and an image obtained when a method for removing image noise according to an embodiment of the present invention is used, noise is removed so that the image (c) is displayed similarly with the original image than the image (b).

The embodiment of the present invention classifies the areas considering the correlation between the sub areas as well as the correlation between pixels of the entire image, making it possible to more effectively specify the characteristics of the image.

Further, since the noise removal filter is designed in consideration of the features of the specified areas and the external environmental factors, the internal/external characteristics of the image is considered in removing noise of the image to enable to properly control the intensity of the noise reduction of the image, making it possible to effectively remove noise component and reproduce high quality image, while preserving the contour and texture of the image and maintaining the definition of the image.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for removing image noise, comprising:
a buffer register that divides image signals in an n*n area obtained from an image sensor into brightness components and chroma components to store them as pixel values;
an image analyzing unit that classifies the n*n area stored in the buffer register into a contour area, a texture area, and a planarization area; and
a noise reduction unit that designs noise removal filters according to the features of the classified areas to reduce image noise.

2. The apparatus for removing image noise according to claim 1, wherein the image analyzing unit includes:
a contour area detection unit that calculates each first absolute difference value in vertical, horizontal, and diagonal directions of two adjacent pixel values based on a center pixel in the n*n area stored in the buffer register and classifies the n*n area into the contour area and an non-contour area using the calculated first absolute difference values to determine a contour direction, and extracts at least one m*m sub area according to the contour direction based on the center pixel and calculates second absolute difference values in the respective sub areas to detect continuity of the contour area; and
a texture area/planarization area detection unit that calculates third absolute difference values of l*l sub areas included in the non-contour area to classify the non-contour area into a texture area and a planarization area.

3. The apparatus for removing image noise according to claim 1, further comprising:
a filter coefficient adjustment unit that assigns weight according to external environmental factors to adjust the coefficients of the noise removal filters.

4. The apparatus for removing image noise according to claim 2, wherein the contour area detection unit compares final absolute difference value that is difference of the first absolute difference values in the vertical/horizontal directions and difference of the first absolute difference values in the diagonal directions with a first threshold value, classifying the n*n area as the contour area if the final absolute difference value is larger than the first threshold value and classifying the n*n area as the non-contour area if the final absolute difference value is smaller than the first threshold value.

5. The apparatus for removing image noise according to claim 2, wherein the contour area detection unit determines a contour direction in a direction vertical to a direction where the largest first absolute difference value of the four first absolute difference values is calculated.

6. The apparatus for removing image noise according to claim 2, wherein the contour area detection unit calculates each second absolute difference value to vertical, horizontal, and diagonal directions of adjacent two pixel values based on the center pixel of the respective m*m sub areas, if the maximum values of the second absolute difference values calculated from the respective sub areas are in the same direction, the contour direction being detected as being continuous in the sub areas of the contour area.

7. The apparatus for removing image noise according to claim 6, wherein if the contour direction in the respective m*m sub areas are detected as being continuous, the noise reduction unit is designed as a first order low pass filter.

8. The apparatus for removing image noise according to claim 2, wherein the texture area/planarization area detection unit calculates third absolute difference values for vertical, horizontal, and diagonal directions based on a center pixel in the l*l sub areas, classifying the l*l sub areas as the planarization area if all of the calculated third absolute difference values are smaller than a third threshold value and classifying the l*l areas as the texture area if at least one of the calculated third absolute difference values is larger than the third threshold value.

9. The apparatus for removing image noise according to claim 1, wherein if the image analyzing unit classifies the n*n area as the planarization area or the texture area, the noise reduction unit classifies the n*n area into five sub areas based on the center pixel of the n*n area and calculates four absolute difference values based on the center pixel of the five sub areas to compare them with a fourth threshold value and thus to design noise removal filters.

10. The apparatus for removing image noise according to claim 1, wherein the noise reduction unit is designed as any one of a first order low pass filter, a second order low pass filter, an intermediate value filter, and a bypass filter.

11. A method for removing image noise, comprising:
dividing image signals in an n*n area obtained from an image sensor into brightness components and chroma components and storing them in a buffer register as pixel values;
classifying the n*n area into a contour area, a texture area, and a planarization area using the pixel values in the n*n area stored in the buffer register; and
designing noise removal filters according to the features of the classified areas.

12. The method for removing the image noise according to claim 11, further comprising:
adjusting coefficients of the noise removal filters by assigning weight according to external environmental factors.

13. The method for removing the image noise according to claim 11, wherein the classifying the n*n area into the contour area, the texture area, and the planarization area includes:
calculating each first absolute difference value to vertical, horizontal, and diagonal directions of adjacent two pixel values based on a center pixel of the n*n area stored in the buffer register;
classifying the n*n area into the contour area and an non-contour area using the calculated first absolute difference values and then determining a contour direction;
extracting at least one m*m sub area based on the center pixel according to the contour direction and calculating second absolute difference values from the respective m*m sub areas to detect continuity of the contour area; and
calculating third absolute difference values in 1*1 sub areas included in the non-contour area and classifying the non-contour area into a texture area and a planarization area.

14. The method for removing the image noise according to claim 13, wherein the classifying the n*n area into the contour area and the non-contour area using the calculated first absolute difference values and then determining the contour direction includes:
comparing final absolute difference values that is the difference between the vertical/horizontal first absolute difference value and the difference between the diagonal first absolute difference value with a first threshold value, classifying the n*n area as the contour area if the final absolute difference value is larger than the first threshold value and classifying the n*n area as the non-contour area when the final absolute difference value is smaller than the first threshold value; and
determining the contour direction to be a direction vertical to a direction that the largest first absolute difference value of the four first absolute difference values is calculated.

15. The method for removing the image noise according to claim 13, wherein the extracting at least one m*m sub area based on the center pixel according to the contour direction and calculating second absolute difference values from the respective m*m sub areas to detect continuity of the contour area includes:
calculating each second absolute difference value to vertical, horizontal, and diagonal directions of adjacent two pixel values based on a center pixel of the respective m*m sub areas; and
when the maximum values of the second absolute difference values extracted from the respective sub areas are in the same direction, detecting the contour direction as being continuous in the sub areas of the contour area.

16. The method for removing the image noise according to claim 13, wherein the calculating the third absolute difference values in l*l sub areas included in the non-contour area and classifying the non-contour area into a texture area and a planarization area includes:
calculating third absolute difference values for vertical, horizontal, and diagonal directions based on a center pixel in the l*l sub areas, classifying the l*l sub areas as the planarization area if all of the calculated third absolute difference values are smaller than a third threshold value and classifying the l*l sub areas as the texture area if at least one of the calculated third absolute difference values is larger than the third threshold value

17. The method for removing the image noise according to claim 16, wherein the designing the noise removal filters according to the features of the classified areas comprises classifying the planarization area or the texture area into five sub areas based on the center pixel in the n*n area, calculating four absolute difference values based on the center pixel of the five sub areas and comparing them with a fourth threshold value to classify the features of the areas and to design noise removal filter according to the features of the respective areas.
